(19) United States
(12) Patent Application Publication
(10) Pub. No.: US 2007/0247838 A1
(43) Pub. Date: Oct. 25, 2007

(54) Underwater Lumination Devices With Solar Power Suppliers

(75) Inventor: Quanwei Fan, Guangzhou City (CN)

Correspondence Address: BARNES & THORNBURG LLP, 11 SOUTH MERIDIAN, INDIANAPOLIS, IN, 46204, US

(73) Assignee: GUANGZHOU FAPU ELECTRONIC & TECHNOLOGY CO., LTD., Guangzhou City (CN)

(21) Appl. No.: 11/625,693

(22) Filed: Jan. 22, 2007

(30) Foreign Application Priority Data
Apr. 24, 2006 (CN) 200620058105.3

(51) Int. Cl. F21V 33/00; F21L 13/00

(52) U.S. Cl. 362/192; 362/101; 362/267; 362/158

(57) ABSTRACT

Disclosed is an underwater lumination device applied to a swimming pool which comprises a solar power supplier, at least one light body being located at a bottom surface of the swimming pool and having a seal housing and a light or luminan, in which the solar power supplier electrically communicates with the light or luminant.

### CROSS REFERENCE TO RELATED APPLICATIONS

The application claims the benefit of Chinese patent application No. 200620058105.3 filed on Apr. 24, 2006 which is explicitly incorporated by reference in its entirety.

### BACKGROUND OF THE INVENTION

1. Field of the Invention

This invention generally relates to a lamination device, and specifically, to an underwater lumination having a solar power supplier.

2. Description of the Prior Art

A conventional underwater limunation light is powered by a low voltage AC power supply which requires a much strict power supply and circuits. Further, the conventional underwater light should be controlled manually, and therefore its assembly and operation are not convenient.

Caution lights are generally used in some natural bathing places along the shore thereof to indicate the boundary between a deeper area and a shallower area. If a low voltage AC power supply is used to provide power for the caution light, the cost is quite high due to longer electrical wires requirements and the maintenance cost therefor.

Thus, there has been a longstanding need for an underwater light which can overcome the shortcomings of the conventional underwater light.

### SUMMARY OF THE INVENTION

The present invention provides an underwater lumination device applied to a swimming pool comprising a solar power supplier, at least one light body being located at a bottom surface of the swimming pool and having a seal housing and a light or luminan, in which the solar power supplier electrically communicates with the light or luminant.

In an embodiment of the invention, the solar power supplier comprises solar cells and a light sensitive element that automatically turns on/off the light or luminant. In another embodiment, the device can further comprise electrical wires to connect the solar power supplier to the light or luminant, and a connecting piece to adjust the length of the wires. In the invention, the connecting piece is preferably fixed to a side wall of the swimming pool.

In another embodiment of the device according to the present invention, it can further comprise a fastening structure to fix the light body to a bottom surface of the swimming pool, and the fastening structure is configured to have the light body rotate perpendicularly and horizontally. Preferably, the fastening structure can comprise an upper portion, a lower portion and a connection portion that pivotedly connects the upper portion and the lower portion, and the upper portion can be fixed to the light body with one end and the lower portion provides a base to fix the fastening structure to the bottom surface of the pool.

In the invention, the base preferably can have a larger bottom area and is made of metal so that the light body can be fixed to the bottom surface of the pool by means of its self-gravity and kept standing.

According to another embodiment of the present invention, the solar power supplier is configured to float over a water surface of the pool. In a specific embodiment, the solar power supplier comprises solar cells, a base to set the solar cells and a support made of plastic or sponge and coupled to the base.

The advantages and features or elements of the present invention can be seen from the following descriptions of some embodiments with reference to the companying drawings.

### BRIEF DESCRIPTION OF THE DRAWINGS

FIG. 1 is a schematic view of an underwater lumination device according to an embodiment of the present invention applied to a swimming pool;

FIG. 12 is a schematic view of an underwater lumination device according to another embodiment of the present invention applied to a bathing place; and

FIG. 3 is a schematic view of an underwater lumination device according to another embodiment of the present invention with a floating solar power supplier.

### DETAIL DESCRIPTION OF THE INVENTION

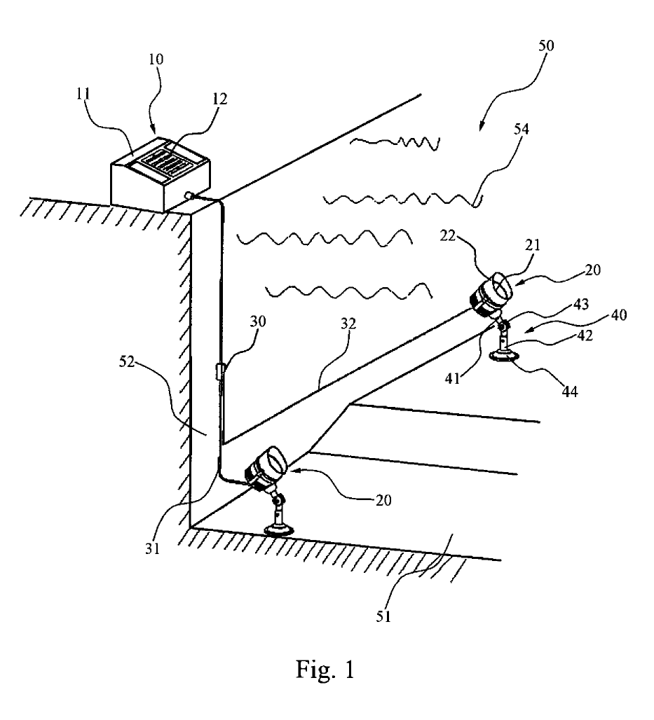

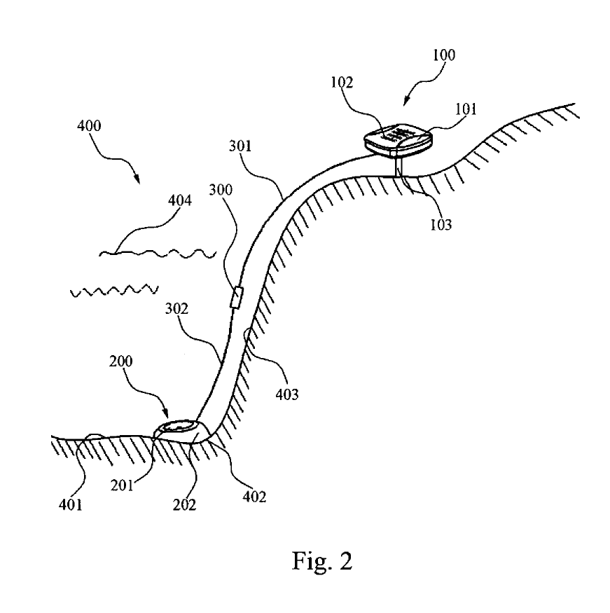

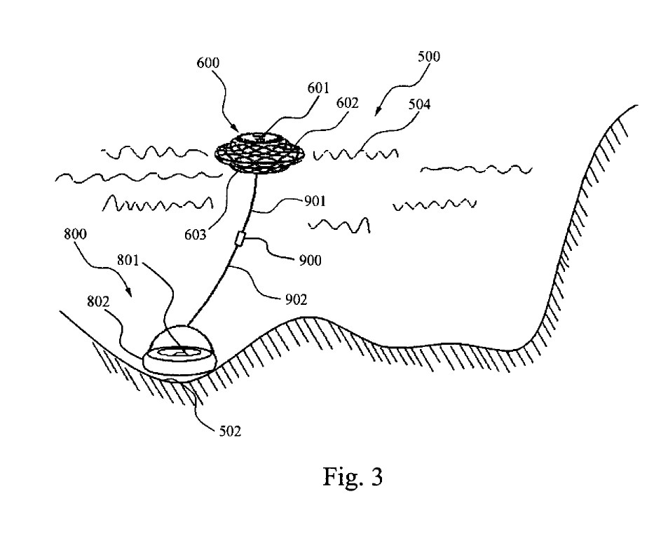

Referring now to FIG. 1, an embodiment according to the present invention is shown. An underwater lumination device in this embodiment is disposed within a common swimming pool 50 including a solar power supplier 10 disposed at a place on the ground close to the pool, and two light bodies 20 disposed at a bottom surface 51 under a water surface 54. There may be other light bodies (not shown).

The light body 20 is fixed to the bottom surface 51 through a fastening structure 40. The solar power supplier 10 is electrically communicated with the light bodies 20 through electrical wires 31 and 32. The electrical wires may be adjusted in length by a connecting piece 30 that can be fixed to a side wall 52 of the pool.

Each of the light bodies provides a seal housing 22 and a light or an illuminant 21 that is sealed within the housing 22 and is powered by the solar power supplier 10.

The fastening structure 40, that may be those well known in the art, in this embodiment comprises an upper portion 41, a lower erection portion 42 and a connection portion 43 that connects the upper portion and the lower portion. The upper portion is fixed to the light body with one end and the lower portion provides a base 44 to fix the fastening structure 40 to the bottom surface of the pool. In this embodiment, the base 44 is made of metal and has such a bottom area that the light body can be fixed to the bottom surface of the pool by means of its self-gravity and kept standing. Alternatively, the base can be fixed to the bottom surface by screws.

The connection portion 43 is configured to have the light body 20 rotate perpendicularly and horizontally with respect to the lower portion so that the light body can be adjusted to light the pool in different directions.

The solar power supplier used in the invention can be those conventionally used in the art such as including solar cells. In this embodiment, the solar power supplier 10 includes solar cells 12 and a light sensitive element 11 so that the light can be automatically controlled. That is, in the daytime the solar power supplier can store solar power and render the light off, and as the sun sets the solar power supplier can automatically power the light.

Now referring to FIG. 2, another embodiment according to the present invention is schematically shown. In this embodiment, the underwater lumination device is used for a natural bathing place 400 including a solar power supplier 100 that is fixed to a bank of the bathing place by an insert 103, and one or more light bodies 200. Electrical wires 301 and 302 are provided to electrically communicate between the light body 200 and the solar power supplier 100.

Similar to the above embodiment, the solar power supplier 100 includes solar cells 102 and a light sensitive element 101 so that the light can be automatically controlled.

The light body 200 in this embodiment may be disposed under a water surface 403 within a pit 401 at the bottom surface 402 of the natural bathing place 400. The light body provides a seal housing 202 and a light or a luminant 201 sealed therein.

The electrical wires can be adjusted in length by a connecting piece 300. The connecting piece 300 can be fixed to a slope 403 of the bathing place if necessary.

FIG. 3 shows another embodiment according to the present invention which is also applied to a natural bathing place 500. An underwater lamination device includes a solar power supplier 600 and one or more light bodies 800. Electrical wires 901 and 902 are provided to electrically communicate the solar power supplier 600 with the light body 800.

The light body 800 is disposed within a pit 502 at the bottom surface of the bathing place 500.

The solar power supplier 600 including solar cells 601 and a base 602 to set the solar cells. The solar power supplier is configured to float over a water surface 504. In this embodiment, the solar power suppler 600 includes a support 603 that is made of plastic or sponge. As shown in FIG. 3, the support 603 is coupled to the base 602. The solar power supplier in this embodiment is configured in the shape of a flying disk.

A connecting piece 900 is provided to regulate the length of the wires 901 and 902.

The underwater device in this embodiment is perfectly used at places far away from the shore.

The above embodiments and descriptions are intended to describe the present invention, but not limited thereto. It should be appreciated by one of ordinary skill in the art that any modifications or variations to the present invention that are not departed from the spirit and concept of the invention can be made.

1. An underwater lumination device applied to a swimming pool comprising:
a solar power supplier; and
at least one light body being located at a bottom surface of the swimming pool and having a seal housing and a light or luminant,
wherein the solar power supplier electrically communicates with the light or luminant.

2. The underwater lumination device of claim 1, wherein the solar power supplier comprises solar cells and a light sensitive element that automatically turns on/off the light or luminant.

3. The underwater lumination device of claim 2 further comprising electrical wires to connect the solar power supplier to the light or luminant, and a connecting piece to adjust the length of the wires.

4. The underwater lumination device of claim 3, wherein the connecting piece is fixed to a side wall of the swimming pool.

5. The underwater lumination device of claim 1 further comprising a fastening structure to fix the light body to a bottom surface of the swimming pool, wherein the fastening structure is configured to have the light body rotate perpendicularly and horizontally.

6. The underwater lumination device of claim 5, wherein the fastening structure comprises an upper portion, a lower portion and a connection portion that pivotedly connects the upper portion and the lower portion, wherein the upper portion is fixed to the light body with one end and the lower portion provides a base to fix the fastening structure to the bottom surface of the pool.

7. The underwater lumination device of claim 6, wherein the base has a larger bottom area and is made of metal so that the light body can be fixed to the bottom surface of the pool by means of its self-gravity and kept standing.

8. The underwater lumination device of claim 2 further comprising a fastening structure to fix the light body to a bottom surface of the swimming pool, wherein the fastening structure is configured to have the light body rotate perpendicularly and horizontally.

9. The underwater lumination device of claim 8, wherein the fastening structure comprises an upper portion, a lower portion and a connection portion that pivotedly connects the upper portion and the lower portion, wherein the upper portion is fixed to the light body with one end and the lower portion provides a base to fix the fastening structure to the bottom surface of the pool.

10. The underwater lumination device of claim 9, wherein the base is made of metal and has such a bottom area that the light body can be fixed to the bottom surface of the pool by means of its self-gravity and kept standing.

11. The underwater lumination device of claim 3 further comprising a fastening structure to fix the light body to a bottom surface of the swimming pool, wherein the fastening structure is configured to have the light body rotate perpendicularly and horizontally.

12. The underwater lumination device of claim 11, wherein the fastening structure comprises an upper portion, a lower portion and a connection portion that pivotedly connects the upper portion and the lower portion, wherein the upper portion is fixed to the light body with one end and the lower portion provides a base to fix the fastening structure to the bottom surface of the pool.

13. The underwater lumination device of claim 12, wherein the base is made of metal and has such a bottom area that the light body can be fixed to the bottom surface of the pool by means of its self-gravity and kept standing.

14. The underwater lumination device of claim 1, wherein the solar power supplier is configured to float over a water surface of the pool.

15. The underwater lumination device of claim 14, wherein the solar power supplier comprises solar cells, a base to set the solar cells and a support made of plastic or sponge and coupled to the base.

16. The underwater lumination device of claim 15, wherein the solar power supplier is configured to be in the shape of a flying disk.

17. The underwater lumination device of claim 5, wherein the solar power supplier is configured to float over a water surface of the pool, and comprises solar cells, a base to set the solar cells and a support made of plastic or sponge and coupled to the base.

18. The underwater lumination device of claim 6, wherein the solar power supplier is configured to float over a water surface of the pool, and comprises solar cells, a base to set the solar cells and a support made of plastic or sponge and coupled to the base.

19. The underwater lumination device of claim 7, wherein the solar power supplier is configured to float over a water surface of the pool, and comprises solar cells, a base to set the solar cells and a support made of plastic or sponge and coupled to the base.
